(19) United States
(12) Patent Application Publication
(10) Pub. No.: US 2019/0283556 A1
(43) Pub. Date: Sep. 19, 2019

(54) SUNROOF DEVICE

(71) Applicant: AISIN SEIKI KABUSHIKI KAISHA, Kariya-shi, Aichi-ken (JP)

(72) Inventor: Akinao YAMAGUCHI, Nagoya-shi (JP)

(73) Assignee: AISIN SEIKI KABUSHIKI KAISHA, Kariya-shi, Aichi-ken (JP)

(21) Appl. No.: 16/347,978

(22) PCT Filed: Nov. 8, 2017
(86) PCT No.: PCT/JP2017/040328

§ 371 Date: May 7, 2019

(30) Foreign Application Priority Data
Nov. 17, 2016 (JP) 2016-224023
Aug. 7, 2017 (JP) 2017-152500

(51) Int. Cl. B60J 7/043; B62D 25/06; B62D 35/00; B60J 7/057

(52) U.S. Cl. CPC B60J 7/0435; B60J 7/0573; B62D 35/001; B62D 25/06

(57) ABSTRACT

This sunroof device is provided with a roof that has: a roof panel formed with an opening; and a front panel and a rear panel that close the opening. In addition, a recessed section that is recessed downward is formed in a center portion in the vehicle width direction at a rear end portion of the roof.

### CROSS-REFERENCE TO RELATED APPLICATIONS

This application is a national phase application of International Application No. PCT/JP2017/040328, filed Nov. 8, 2017, and claims the priority of Japanese Application Nos. 2016-224023, filed Nov. 17, 2016, and 2017-152500, filed Aug. 7, 2017, the content of each of which is incorporated herein by reference.

### TECHNICAL FIELD

The present invention relates to a sunroof device.

### BACKGROUND ART

A pagoda roof and a double-bubble roof are known roofs of vehicles such as automobiles that are relatively recessed at the central portion with respect to the transverse direction of the vehicle. Such a concave roof accelerates the air flowing along the contour of the roof at the recessed portion as the vehicle travels to improve the aerodynamic performance.

A known sunroof device is configured to open and close part of the vehicle roof so that a feeling of exhilaration can be obtained (for example, patent document 1). It is desired that the aerodynamic performance of the sunroof device also be improved in the same manner as a concave roof. Typically, even if the model is the same, there are vehicles equipped with a sunroof device and vehicles that are not equipped with a sunroof device. Thus, it is desired that the level of aerodynamic performance be the same regardless of the difference in specification with regard to the sunroof.

### PRIOR ART DOCUMENTS

### Patent Document

Patent Document 1: Japanese Laid-Open Patent Publication No. 2005-162063

### SUMMARY OF THE INVENTION

### Problems that the Invention is to Solve

It is an objective of the present disclosure to provide a sunroof device that further improves the aerodynamic performance of a vehicle.

### Means for Solving the Problems

In one general aspect, a sunroof device includes a roof including a roof panel having an opening and a panel that closes the opening. Further, the sunroof device includes a recess recessed downward in a central portion, with respect to a vehicle transverse direction, of a rear end of the roof.

### BRIEF DESCRIPTION OF THE DRAWINGS

FIG. 1A is a perspective view of a sunroof device in accordance with a first embodiment of the present invention in a fully closed state.

FIG. 1B is a perspective view of the sunroof device in a fully open state.

FIG. 2A is a schematic diagram illustrating the behavior of flow of air along a roof of the sunroof device.

FIG. 2B is a schematic diagram illustrating the behavior of the flow of air along a roof subject to comparison.

FIG. 3A is a graph comparing a vehicle air resistance coefficient between the roof of the sunroof device and the roof subject to comparison.

FIG. 3B is a graph comparing a vehicle lift coefficient between the roof of the sunroof device and the roof subject to comparison.

FIG. 4 is a plan view showing the structure of a shade mechanism.

FIG. 5 is a cross-sectional view taken along line 5-5 in FIG. 4.

FIG. 6 is an exploded perspective view of a winding pipe and its peripheral structure.

FIG. 7 is an exploded perspective view of a motor housing.

FIG. 8 is a perspective view of a drum and its peripheral structure.

FIGS. 9A and 9B are cross-sectional views illustrating the action of a first cable wound around the drum.

FIGS. 10A and 10B are cross-sectional views illustrating the action of a second cable wound around the drum.

FIG. 11 is a perspective view of a pulley and its peripheral structure.

FIG. 12 is a cross-sectional view taken along line 12-12 in FIG. 11.

FIG. 13 is a cross-sectional view taken along line 13-13 in FIG. 11.

FIG. 14 is a schematic view illustrating the operation of the sunroof device.

FIG. 15 is a perspective view showing a modified example of a sunroof device in a fully closed state.

FIG. 16 is a plan view showing the structure of a shade mechanism of a sunroof device in accordance with a second embodiment of the present invention.

FIG. 17 is a cross-sectional view taken along line 17-17 in FIG. 16.

FIG. 18 is an exploded perspective view of the winding pipe and its peripheral structure.

FIG. 19 is a plan view of a shoe member and its peripheral structure.

FIG. 20 is an exploded perspective view showing the coupling structure of a pulley.

FIG. 21 is a schematic view illustrating the operation of the sunroof device.

### MODES FOR CARRYING OUT THE INVENTION

### First Embodiment

A sunroof device in accordance with a first embodiment will now be described. Hereinafter, directions in which a vehicle moves forward and rearward will be referred to as the forward and rearward directions and a height direction of the vehicle will be referred to as the vertical direction. Further, in a vehicle transverse direction, a side facing toward the inside of a passenger compartment will be referred to as the inner side and a side facing toward the outside of the passenger compartment will be referred to as the outer side.

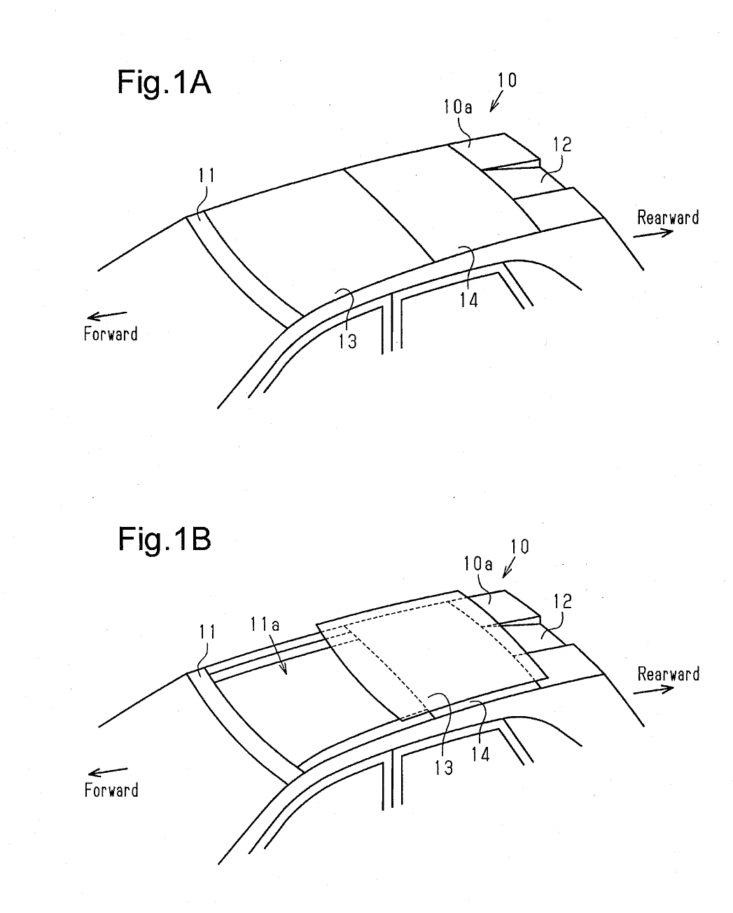

As shown in FIGS. 1A and 1B, a roof 10 of a vehicle such as an automobile includes a roof panel 11 including a substantially rectangular opening 11a. The roof 10 includes a recess 12 at a rear end 10a. The recess 12 is recessed downward in a central portion with respect to the vehicle transverse direction. The roof 10 is a concave roof.

The roof 10 includes a front panel 13 and a rear panel 14. The front panel 13 and the rear panel 14 are substantially rectangular panels formed by, for example, glass plates or synthetic resin plates. The front panel 13 and the rear panel 14 are arranged next to each other in the forward and rearward directions. The front panel 13 is coupled to the roof panel 11 to open and close the front part of the opening 11a. The front panel 13 is configured to perform a tilt-up action lifting its rear portion using its front portion as a fulcrum, and a slide action in the forward or rearward direction. An outer sliding system is employed to slide and open or close the front panel 13 in a tilt-up state. The rear panel 14 is coupled to the roof panel 11 so that a rear part of the opening 11a is always closed. The front panel 13 and the rear panel 14 form a light transmissive area in the opening 11a.

The behavior of flow of air along the roof 10 when the vehicle is traveling will now be described. Hereinafter, the direction in which the air flows will be indicated by arrows. In particular, the length of a straight arrow is correlated with the flow velocity of air.

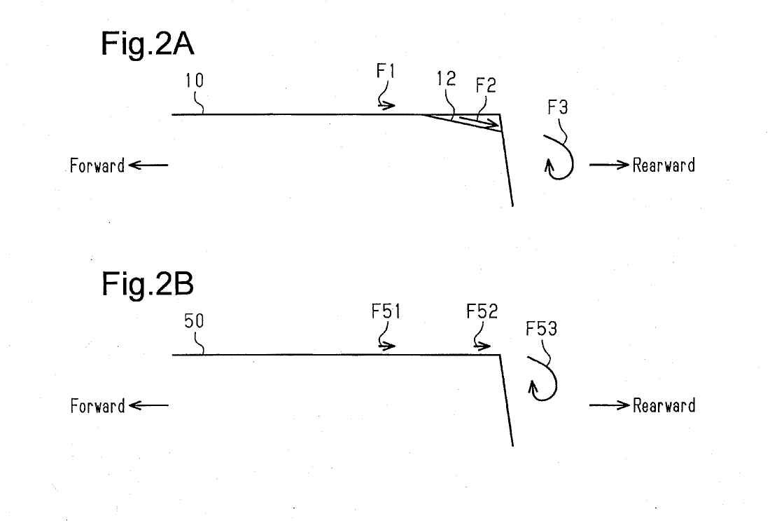

As shown in FIG. 2A, air F1 flows through the central portion of the roof 10 with respect to the vehicle transverse direction toward the recess 12. The flow velocity of air F1 is relatively low but accelerated when reaching the recess 12 to air F2. This draws the wind produced when the vehicle is traveling and reduces the air resistance. Then, air F3, which is swirl-generated at the rear of the vehicle, moves away from the vehicle and reduces the air resistance.

FIG. 2B shows a comparison subject roof 50 that is similar in shape as the roof 10 except in that the recess 12 is omitted. Air F51 flows though the central portion of the comparison subject roof 50 with respect to the vehicle transverse direction and reaches the rear end of the comparison subject roof 50 as relatively slow air F52. Consequently, air F53, which is swirl-generated at the rear of the vehicle, approaches the vehicle and increases the air resistance.

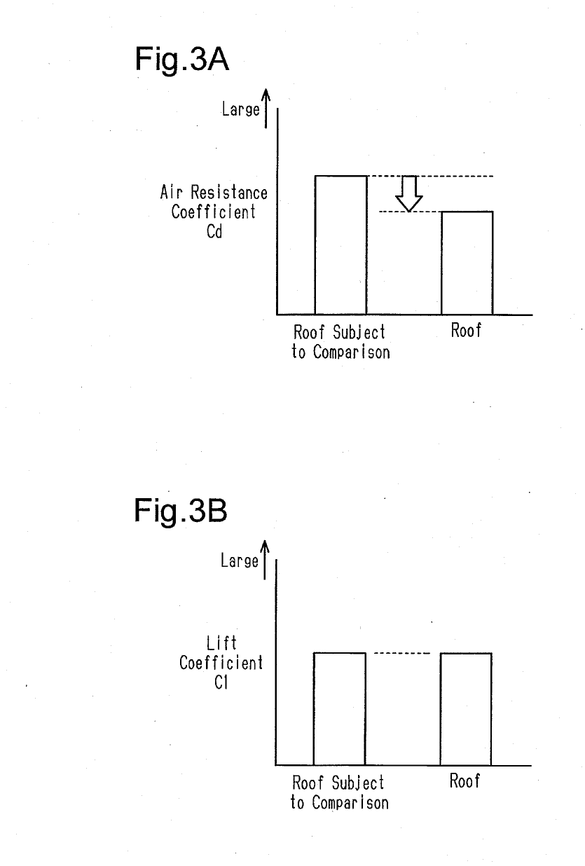

FIG. 3A is a graph comparing a vehicle air resistance coefficient Cd between the roof 10 and the comparison subject roof 50. As illustrated in FIG. 3A, the recess 12 decreases the vehicle air resistance coefficient Cd.

FIG. 3B is a graph comparing a vehicle lift coefficient C1 between the roof 10 and the comparison subject roof 50. As illustrated in FIG. 3B, the recess 12 does not change the vehicle lift coefficient C1.

A roller shade system of the present embodiment will now be described.

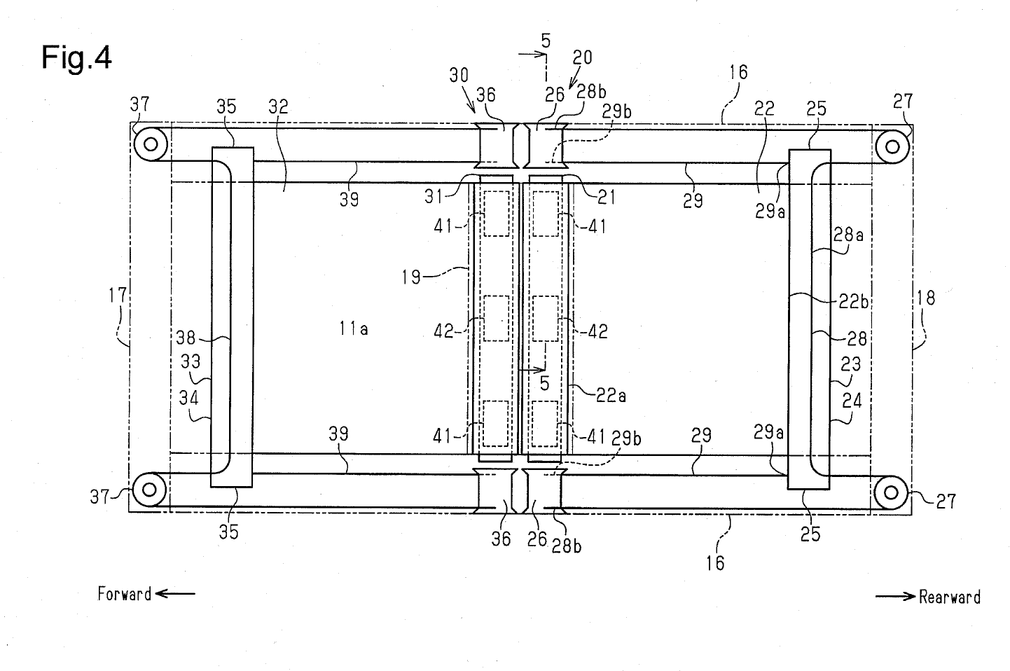

As shown in FIG. 4, two guide rails 16 are arranged at two edges of the opening 11a extending in the forward and rearward directions. The guide rails 16 are, for example, formed by extruding aluminum alloy. The front ends of the two guide rails 16 are connected by a front housing 17, which extends in the vehicle transverse direction. The rear ends of the two guide rails 16 are connected by a rear housing 18, which extends in the vehicle transverse direction. The middle parts of the guide rails 16 are connected by a center housing 19, which extends in the vehicle transverse direction along a boundary between the front panel 13 and the rear panel 14.

A rear shade mechanism 20 is arranged in the rear part of the opening 11a. The rear shade mechanism 20 includes a substantially cylindrical winding pipe 21 that serves as a winding shaft. The winding pipe 21 extends along a rear part of the center housing 19 in the vehicle transverse direction. The winding pipe 21 is rotatably supported about an axis extending in the vehicle transverse direction.

A light shielding sheet 22 is fixed to the winding pipe 21. The light shielding sheet 22 conforms to a deployed state, which blocks the light passing through the rear panel 14, or a retracted state, which permits the passage of light. The light shielding sheet 22 includes a first edge 22a, which is a front edge, fixed to the winding pipe 21. The light shielding sheet 22 is configured to be wound to and unwound from the rotating winding pipe 21.

The light shielding sheet 22 includes a second edge 22b, which is a rear edge, fixed to an operation member 23. The operation member 23 extends between the two guide rails 16 in the vehicle transverse direction rearward from the winding pipe 21 so as to bridge the guide rails 16. The operation member 23 includes a substantially elongated handle 24 and two shoe members 25. The handle 24 extends across the guide rails 16. The shoe members 25 are attached to two ends of the handle 24 and slidably arranged on the guide rails 16, respectively. The second edge 22b of the light shielding sheet 22 is fixed to the operation member 23 at the handle 24, which extends along the second edge 22b.

The handle 24 is moved rearward while sliding the shoe members 25 of the operation member 23 on the guide rails 16. In this case, the light shielding sheet 22 is unwound from the winding pipe 21 so as to block the light passing through the rear panel 14. Alternatively, the handle 24 is moved forward while sliding the shoe members 25 of the operation member 23 on the guide rails 16. In this case, the light shielding sheet 22 is wound around the winding pipe 21 so as to permit the passage of light through the rear panel 14.

A drum 26 is rotatably supported coaxially with the winding pipe 21 on each guide rail 16 adjacent to the outer side of the winding pipe 21. Further, a pulley 27, which serves as a direction changing member, is rotatably supported about an axis extending in the vertical direction on each end of the rear housing 18 rearward from the guide rails 16.

A first cable 28, which is a single cable, is fixed to the handle 24. The first cable 28 is fixed to a linking part 28a arranged on the handle 24 in a longitudinal direction of the handle 24. The first cable 28 extends out of the two ends of the handle 24 and changes directions at the shoe members 25 to extend toward the rear. The first cable 28 runs around the pulleys 27 from the inner side to change directions and further extend toward the front. The first cable 28 includes two terminal ends 28b extending toward the front that are fixed to the drums 26 so as to be wound around and unwound from the drum 26.

A second cable 29 includes a first terminal end 29a fixed to the shoe member 25 and a second terminal end 29b fixed to the drum 26. The first and second cables 28 and 29 are wound around the drum 26 in opposite directions. That is, for example, when the drum 26 is rotated to wind the first cable 28, the second cables 29 are unwound from the drum 26.

The winding pipe 21 incorporates two motors 41 that serve as electric drive sources. The motors 41 rotate and drive the drums 26. Further, the winding pipe 21 incorporates a biasing member that biases the winding pipe 21 in a rotation direction that winds the light shielding sheet 22. For example, the biasing member is a torsion coil spring 42.

When the two motors 41 rotate and drive the drums 26 in one direction in a state in which the light shielding sheet 22 is wound, the two terminal ends 28b of the first cable 28 are wound around the drums 26 and the second cables 29 are unwound from the drums 26. This slides the shoe members 25 on the guide rails 16 and moves the handle 24 rearward. In this manner, the light shielding sheet 22 is unwound from the winding pipe 21 against the biasing force of the biasing member 42, and the second edge 22b of the light shielding sheet 22, which is fixed to the handle 24, is moved rearward. Accordingly, the light shielding sheet 22 blocks some of the light passing through the rear panel 14 in accordance with the amount the second edge 22b moved. Further, when the handle 24 is moved rearward by the maximum amount to the proximity of the rear housing 18, the light shielding sheet 22 blocks the light passing through the rear panel 14.

For example, when the light shielding sheet 22 is stopped during a closing action, the second cables 29 restrict further closing that is manually performed.

In contrast, when the motors 41 rotate and drive the drums 26 in a reverse direction, the two terminal ends 28b of the first cable 28 are unwound and the second cables 29 are wound. This slides the shoe members 25 on the guide rails 16 and moves the handle 24 forward. Accordingly, the second edge 22b of the light shielding sheet 22, which is fixed to the handle 24, is moved forward. As a result, the light shielding sheet 22, which tends to slacken, is biased by the biasing member 42 and wound around the winding pipe 21. Further, when the operation member 23 of the handle 24 is moved forward by the maximum amount to the proximity of the center housing 19, the light shielding sheet 22 permits the passage of light through the rear panel 14.

A front shade mechanism 30 is arranged in the front part of the opening 11a. The front shade mechanism 30 is basically the same as the rear shade mechanism 20 except in that the forward and rearward directions are reversed. That is, the front shade mechanism 30 includes a winding pipe 31, a light shielding sheet 32, an operation member 33 (handle 34, shoe members 35), drums 36, pulleys 37, a first cable 38, and second cables 39. When the handle 34 is moved forward while sliding the two shoe members 35 of the operation member 33 on the guide rails 16, the light shielding sheet 32 is unwound from the winding pipe 31 so as to block the light passing through the front panel 13. When the handle 34 is moved rearward while sliding the two shoe members 35 of the operation member 33 on the guide rails 16, the light shielding sheet 32 is wound around the winding pipe 31 so as to permit the passage of light.

The winding pipe 21 and its peripheral structure will now be described.

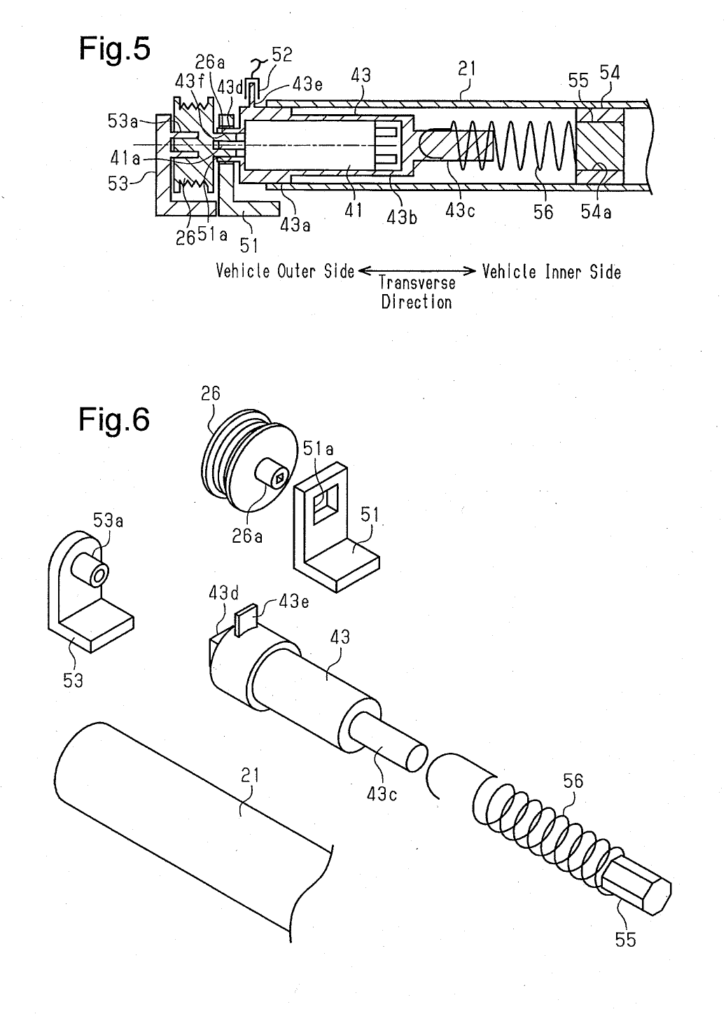

As shown in FIGS. 5 and 6, a substantially L-shaped bracket 51 is attached to each guide rail 16 adjacent to the outer side of the winding pipe 21. The bracket 51 includes a substantially rectangular fitting hole 51a that is concentric with the winding pipe 21 and opens in the vehicle transverse direction. A motor housing 43 is attached to the open end of the winding pipe 21 opposing the bracket 51. The motor housing 43 includes a bearing portion 43a that is substantially cylindrical and includes a closed end. The bearing portion 43a has an outer diameter that is equal to the inner diameter of the winding pipe 21. The motor housing 43 further includes an extension portion 43b that is substantially cylindrical and includes a closed end. The extension portion 43b has a smaller diameter than the bearing portion 43a and is connected to an inner end of the bearing portion 43a. The motor housing 43 further includes a substantially post-shaped spring seat 43c that is connected to an inner end of the extension portion 43b. The motor housing 43 further includes a fitting projection 43d that has the form of a rectangular post that is concentric with the bearing portion 43a. The fitting projection 43d is connected to an outer end of the bearing portion 43a.

In the motor housing 43, the fitting projection 43d is fitted into the fitting hole 51a of the bracket 51 in a state in which the bearing portion 43a is rotatably inserted in the winding pipe 21. Accordingly, the motor housing 43 that is fixed to the guide rail 16 by the bracket 51 supports the winding pipe 21 at the bearing portion 43a. Preferably, the inner circumferential surface of the winding pipe 21 that contacts the bearing portion 43a is treated with a synthetic resin having a low friction coefficient. The synthetic resin includes a fluororesin such as Teflon (registered trademark).

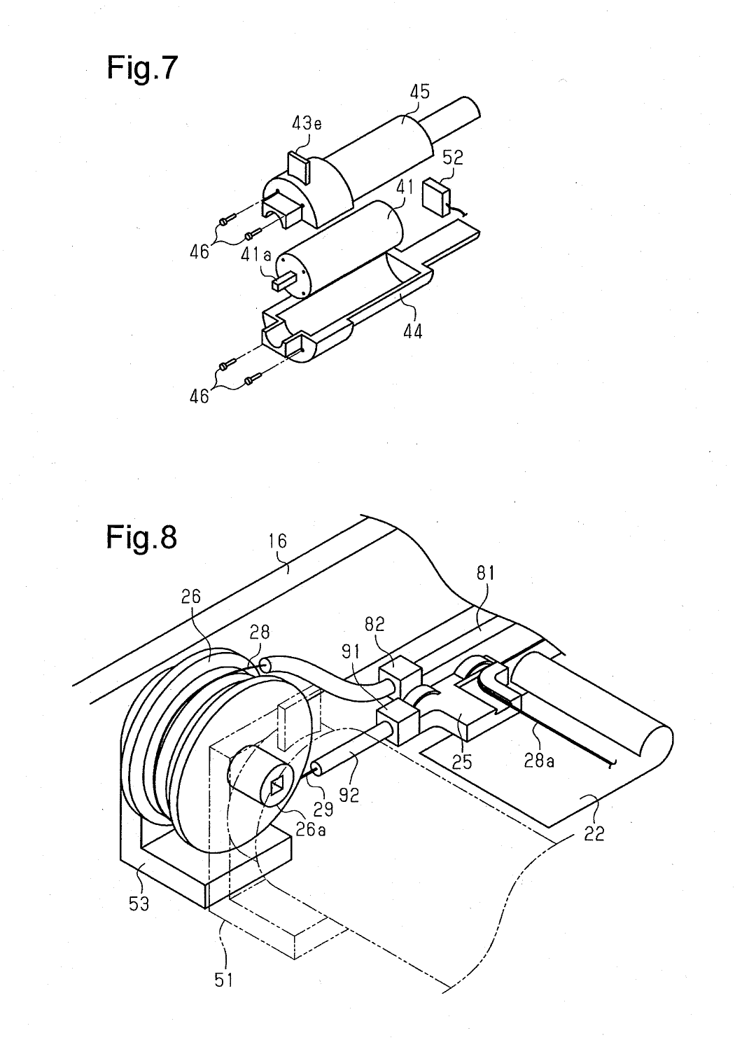

The motor housing 43 accommodates the motor 41 in an inner space defined by the bearing portion 43a and the extension portion 43b. As shown in FIG. 7, the motor housing 43 is divided along a plane lying along a center line into two segments, namely, a first housing portion 44 and a second housing portion 45. The motor 41 is held between the first and second housing portions 44 and 45 in a state accommodated in a substantially semi-circular inner space defined in each of the first housing portion 44 and second housing portion 45. The motor 41 is fastened to the motor housing 43 by bolts 46.

As shown in FIGS. 5 and 6, the bearing portion 43a includes a motor connector 43e at an outer portion projecting from the winding pipe 21. The motor connector 43e has the form of a substantially a rectangular post projecting outward in a radial direction. The motor connector 43e is electrically connected to two terminal ends of the motor 41 and fitted into a substantially box-shaped battery connector 52 electrically connected to a power source such as an in-vehicle battery. The motor 41 is supplied with power from the power source via the motor connector 43e and the battery connector 52.

The fitting projection 43d includes a circular bearing hole 43f that is concentric with the fitting projection 43d. A rotation shaft 41a of the motor 41, which extends through the bearing portion 43a, is arranged in the inner circumferential portion of the bearing hole 43f. The rotation shaft 41a is shaped to have the form of a substantially rectangular post. A substantially L-shaped bracket 53 is attached to each guide rail 16 adjacent to the outer side of the bracket 51. The bracket 53 includes a cylindrical bearing portion 53a that is concentric with the rotation shaft 41a and projects toward the inner side. The drum 26 is supported by the bearing portion 53a. The drum 26 is held between the bearing portion 53a and the bracket 51. The drum 26 includes a connection portion 26a that is a circular post, concentric with the rotation shaft 41a, and projects toward the inner side. The rotation shaft 41a is fitted into the connection portion 26a. In this state, the connection portion 26a is supported by the bearing hole 43f so as to be rotated integrally with the rotation shaft 41a. In this manner, the motor 41 rotates and drives the drum 26.

A substantially ring-shaped holder 54 is fitted in a central portion of the winding pipe 21 in a non-rotatable manner. The holder 54 includes a substantially octagonal engagement hole 54a that is concentric with the winding pipe 21 and opens in the vehicle transverse direction. The engagement hole 54a is engaged with a substantially octagonal end member 55. The end member 55 is fixed to a first leg of a torsion spring 56, which is a coil spring. A second leg of the torsion spring 56 is hooked to the spring seat 43c of the motor housing 43. Accordingly, the rotation of the winding pipe 21 around the motor housing 43 changes the twisted amount (biasing force) of the torsion spring 56. In the present embodiment, the twisted amount of the torsion spring 56 increases as the winding pipe 21 rotates in a direction in which the light shielding sheet 22 is unwound. The torsion spring 56 is twisted in synchronization with the rotation of the winding pipe 21.

The first and second cables 28 and 29 that are fixed to the drums 26 will now be described.

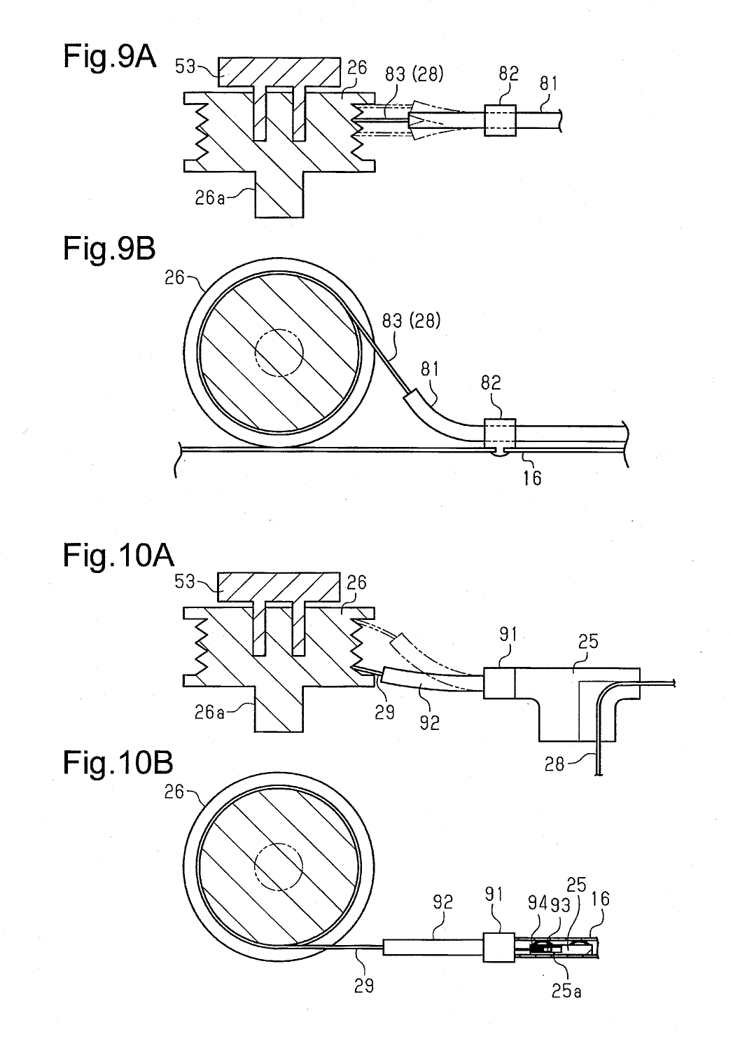

As shown in FIG. 8, an outer tube 81 is laid out between the drum 26 and the pulley 27. The outer tube 81 includes a distal end that is proximate to the drum 26 and coupled to the guide rail 16 by a clamp 82. The first cable 28 includes a first cable portion 83 that is inserted into the outer tube 81 and laid out between the drum 26 and the pulley 27. The first cable 28 is fixed to the drum 26 at a distal end of the first cable portion 83 exposed from the outer tube 81. Thus, as shown in FIGS. 9A and 9B, when the first cable portion 83 swings together with the outer tube 81 in the axial direction of the drum 26 about the clamp 82 as the drum 26 rotates, the first cable portion 83 follows the rotation of the drum 26. The distal end exposed from the outer tube 81 of the first cable portion 83 extends toward an upper part of the drum 26 and is wound counterclockwise as viewed in the drawing [FIGS. 9A and 9B].

As shown in FIG. 8, a stopper 91 is attached to the guide rail 16 in accordance with the arrangement of the corresponding shoe member 25 of the light shielding sheet 22 in the retracted state. An end of an outer tube 92 that is laid out between the stopper 91 and the drum 26 is fixed to the stopper 91. The second cable 29 is fixed to the drum 26 at a distal end exposed from the outer tube 92. Thus, as shown in FIGS. 10A and 10B, when the second cable 29 swings together with the outer tube 92 in the axial direction of the drum 26 about the stopper 91 as the drum 26 rotates, the second cable 29 follows the rotation of the drum 26. The distal end exposed from the outer tube 92 of the second cable 29 extends toward a lower part of the drum 26 and is wound clockwise as viewed in the drawing [FIGS. 10A and 10B].

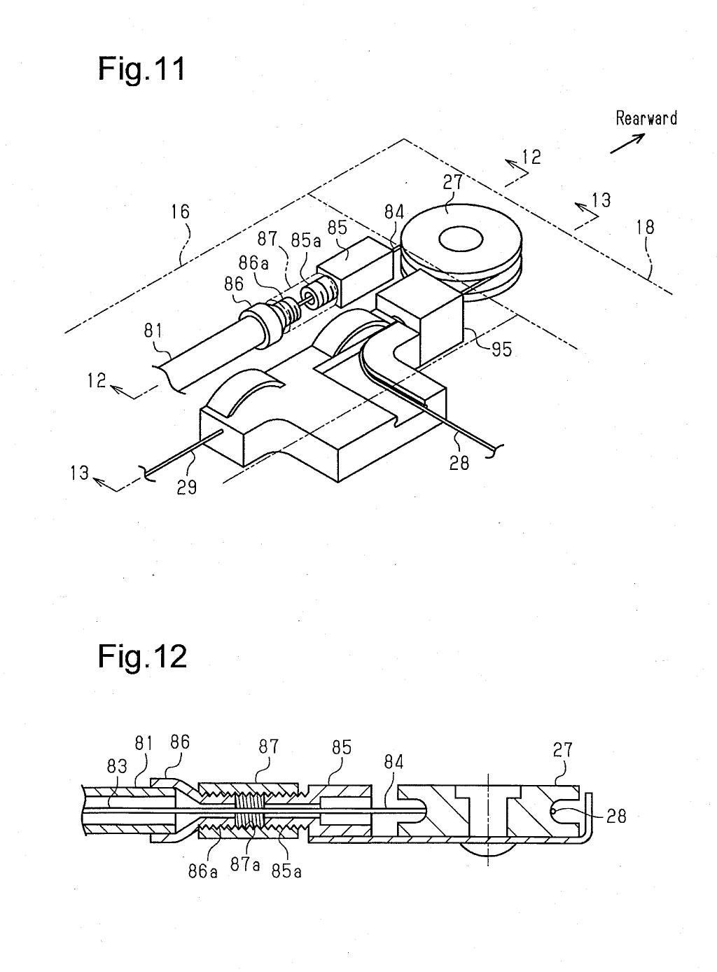

As shown in FIGS. 11 and 12, the first cable 28 includes a second cable portion 84 that is laid out between the pulley 27 and the outer tube 81 and continuous with the first cable portion 83. The second cable portion 84 is inserted into a substantially tubular cable guide 85. The cable guide 85 is fixed to the guide rail 16 opposing the outer tube 81. The cable guide 85 includes a distal end part where a male thread 85a is formed. The first cable portion 83 is inserted into a substantially tubular cable guide 86. The cable guide 86 is attached to the distal end of the outer tube 81 and opposes the cable guide 85. The cable guide 86 includes a distal end part where a male thread 86a is formed. The male threads 85a and 86a are joined with a female threaded portion 87a that is formed in a substantially tubular adjustment member 87. The adjustment member 87 is turned relative to the cable guides 85 and 86 to adjust the tension on the first cable portion 83 of the first cable 28 by extending and retracting the outer tube 81. The adjustment member 87 is turned in one direction and tightened to move the cable guides 85 and 86 toward each other and extend the outer tube 81 so as to increase the tension on the first cable portion 83 of the first cable 28.

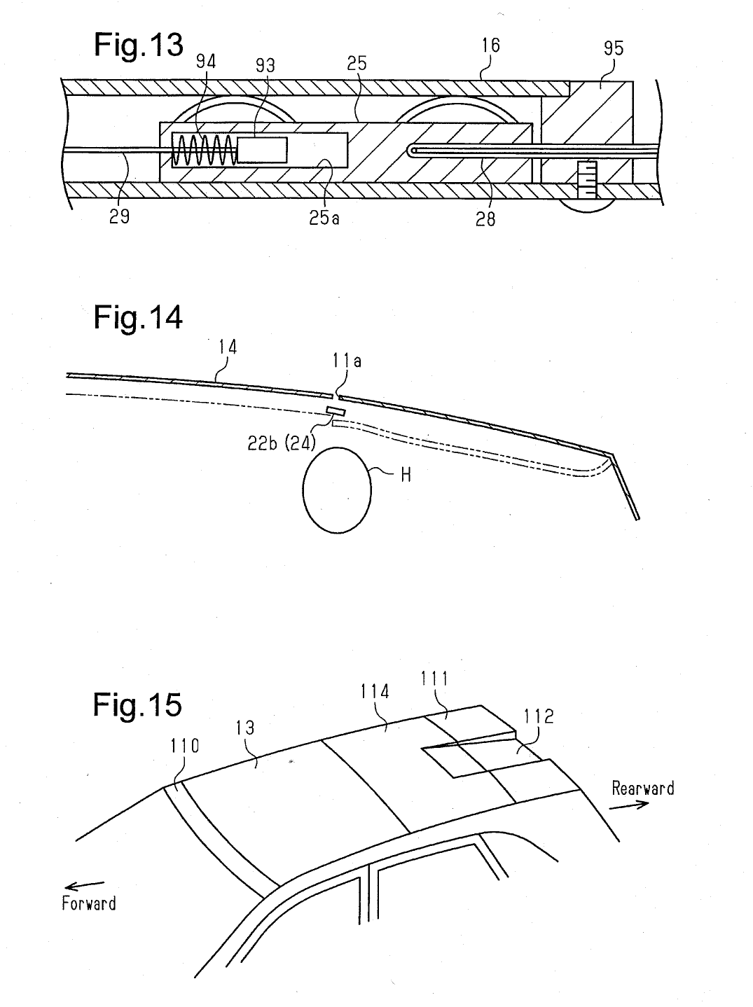

As shown in FIG. 13, each shoe member 25 includes an accommodation portion 25a that is substantially concentric with the second cable 29. The distal end of the second cable 29 that enters the accommodation portion 25a is fixed to a cable end member 93. The cable end member 93 is slidable along the accommodation portion 25a in the forward and rearward directions. A spring 94 is wound around the distal end of the second cable 29, which is located in the accommodation portion 25a. The spring 94 is located between a wall surface of the accommodation portion 25a and the cable end member 93. Thus, the second cable 29 is constantly pulled by the spring 94 in the accommodation portion 25a toward the shoe member 25. This limits slack in the second cables 29 even when a rotation difference occurs between the two drums 26 or when the outer tube 92 extends and retracts. A stopper 95 is attached to the guide rail 16 in accordance with the arrangement of the corresponding shoe member 25 of the light shielding sheet 22 in the deployed state.

The front shade mechanism 30 also has the structures shown in FIGS. 5 to 13. These structures are basically the same as the rear shade mechanism 20 except in that the forward and rearward directions are reversed.

The operation and advantages of the first embodiment will now be described.

(1) The sunroof device has a sunroof that opens or closes the front part of the opening 11a with the front panel 13 and closes the rear part of the opening 11a with the rear panel 14 to obtain the feeling of exhilaration. The recess 12 allows the sunroof device to have further improved aerodynamics performance.

(2) The motor 41 and the biasing member 42 are both incorporated in the winding pipe 21. Thus, the space provided rearward from the winding pipe 21 only needs to be large enough to correspond to the vertical dimensions of the second edge 22b of the light shielding sheet 22, or the handle 24. This allows the recess 12 to be formed while limiting the effects of the action of the light shielding sheet 22. That is, the second edge 22b of the light shielding sheet 22 requires space of small vertical dimensions. Thus, the rear shade mechanism 20 can be installed even when the central portion of the roof panel 11 with respect to the vehicle transverse direction is recessed to form the recess 12.

Further, as shown in FIG. 14, even when the second edge 22b of the deployed light shielding sheet 22, or the rear end of the opening 11a, is located above a head H of a passenger in a rear seat, sufficient space can be provided near the head H since there is no need to arrange a motor above the head H. This obtains a sufficient amount of opening for the entrance of light through the rear panel 14 and further obtains the sense of freedom. This further improves the marketability of the sunroof device.

(3) The sunroof device includes the motor 41 that unwinds the light shielding sheet 22. However, the rotation of the motor 41 is not synchronized with the rotation of the winding pipe 21, and the first cable 28 is wound by the two drums 26. Thus, even when the occurrence of a rotation difference between the left and right drums 26 desynchronizes rotation of the left and right drums 26 when deploying the light shielding sheet 22, the first cable 28 is adjusted to evenly move the light shielding sheet 22 so that the light shielding sheet 22 is moved parallel to the forward and rearward directions. This limits the formation of creases in the light shielding sheet 22.

(4) When the second cables 29 are wound as the drums 26 rotate in the reverse direction, the operation member 23 is moved forward together with the second edge 22b of the light shielding sheet 22. In this case, the winding pipe 21 is rotated while the biasing force of the biasing member 42 maintains the tension on the light shielding sheet 22. This limits the formation of creases in the light shielding sheet 22.

(5) The biasing member 42 biases the winding pipes 21 and 31 in the rotation directions winding the light shielding sheets 22 and 32. This limits formation of creases in the light shielding sheets 22 and 32.

(6) Vehicles of the same model can include the recess 12 regardless of whether the vehicle includes a sunroof. This reduces differences in design resulting from the specification and obtains the same level of the aerodynamic performance.

### Second Embodiment

The sunroof device in accordance with a second embodiment will now be described. The second embodiment differs from the first embodiment in the roller shade system. Thus, those components that are the same as the corresponding components of the first embodiment will not be described in detail.

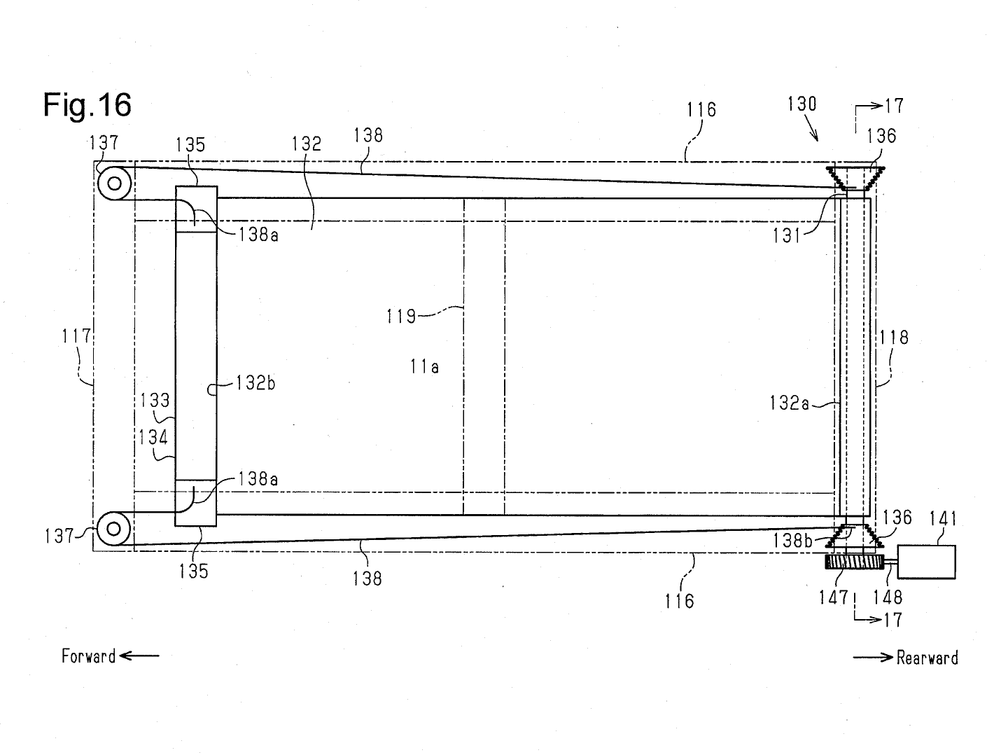

As shown in FIG. 16, the sunroof device of the second embodiment also includes two guide rails 116, a front housing 117, a rear housing 118, and a center housing 119 in a manner similar to the first embodiment.

A shade mechanism 130 is arranged in the opening 11a. More specifically, the shade mechanism 130 includes a substantially cylindrical winding pipe 131 that serves as a winding shaft. The winding pipe 131 extends along the rear housing 118 in the vehicle transverse direction. The winding pipe 131 is located below a rear end of the rear panel 14 at a second position. The winding pipe 131 has a smaller outer diameter than the winding pipes 21 and 31. The winding pipe 131 is rotatably supported about an axis extending in the vehicle transverse direction.

A light shielding sheet 132 is fixed to the winding pipe 131. The light shielding sheet 132 conforms to a deployed state that blocks the light passing through the front panel 13 and the rear panel 14 or a retracted state that permits the passage of light. The rear end of the light shielding sheet 132, namely, the first end 132a, is fixed to the winding pipe 131. The light shielding sheet 132 is configured to be wound to and unwound from the rotating winding pipe 131.

The front end of the light shielding sheet 132, namely, the second end 132b, is fixed to an operation member 133. The operation member 133 extends between the guide rails 116 in the vehicle transverse direction to bridge the guide rails 116 in front of the winding pipe 131. The operation member 133 includes a substantially elongated handle 134 and two shoe members 135. The handle 134 extends across the guide rails 116. The shoe members 135 are attached to two longitudinal ends of the handle 134 and slidably arranged on the guide rails 16, respectively. The second end 132b of the light shielding sheet 132 is fixed to the operation member 133 at the handle 134, which extends along the second end 132b.

The shoe members 135 of the operation member 133 are slid on the guide rails 116 and the handle 134 is moved forward (first direction). In this case, the light shielding sheet 132 is unwound from the winding pipe 131 so as to block the light passing through the front panel 13 and the rear panel 14. Alternatively, the handle 134 of the operation member 133 is moved rearward (second direction). In this case, the light shielding sheet 132 is wound around the winding pipe 131 to permit the passage of light through the front panel 13 and the rear panel 14.

Each end of the winding pipe 131 is attached to a drum 136 by an adhesive. The drums 136 are substantially conic and located coaxially with the winding pipe 21. Thus, the drums 136 are rotated integrally with the winding pipe 131. Further, each end of the front housing 117, which is located in front of the guide rails 116, supports a pulley 137 rotatably about an axis extending in the vertical direction.

A cable 138 is fixed to each of the shoe members 135 of the operation member 133. The cable 138 is fixed to a linking portion 138a laid out in the vehicle transverse direction on the shoe member 135. The cable 138 extends toward the front from an outer end of the linking portion 138a. Then, the cable 138 runs around the pulley 137 from the inner side to change directions and extend rearward. Each cable 138 extending rearward includes a terminal end 138b that is fixed to the drum 136 so as to be wound to and unwound from the drum 136.

The direction in which the cables 138 are wound around the drums 136 is opposite to the direction in which the light shielding sheet 132 is wound around the winding pipe 131. That is, when the winding pipe 131 is rotated to wind the light shielding sheet 132, the cables 138 are unwound from the drums 136. In this case, the position where each cable 138 is unwound shifts from a small diameter side toward a larger diameter side of the drum 136, that is, from the inner side of the drums 136 toward the outer side. This is to increase the unwinding amount of the cable 138 as the winding amount of the light shielding sheet 132 increases for a single rotation of the winding pipe 131 because the roll diameter of the light shielding sheet 132 increases during winding.

A worm wheel 147, which serves as a driven gear, is fixed to one end of the winding pipe 131 in the vehicle transverse direction (lower side of drawing [FIG. 16]) adjacent to the outer side of the drum 136. The worm wheel 147 is fixed to the winding pipe 131 by an adhesive and rotated integrally with the winding pipe 131. Further, a motor 141, which serves as an electric drive source, is arranged on one end of the rear housing 118 in the vehicle transverse direction (lower side in drawing [FIG. 16]) adjacent to the worm wheel 147. The rotation shaft of the motor 141 is fixed to a worm 148 that engages with the worm wheel 147 and serves as a driving gear. Thus, the motor 141 drives and rotates the worm wheel 147 together with the winding pipe 131 and the two drums 136.

When the motor 141 rotates and drives the worm wheel 147 together with the winding pipe 131 and the drums 136 in one direction when the light shielding sheet 132 is in the retracted state, the terminal ends 138b of the two cables 138 are wound around the drums 136. This slides the shoe members 135 on the guide rails 116 forward and moves the second end 132b of the light shielding sheet 132 forward. Thus, the light shielding sheet 132 is unwound from the winding pipe 131. Accordingly, the light shielding sheet 132 blocks some of the light passing through the front panel 13 and the rear panel 14 in accordance with the amount the second end 132b moved. When the handle 134 is moved toward the front by the maximum amount to the proximity of the front housing 117, the light shielding sheet 132 blocks the light passing through the front panel 13 and the rear panel 14.

When the motor 141 rotates and drives the worm wheel 147 together with the winding pipe 131 and the two drums 136 in the reverse direction, the light shielding sheet 132 is wound around the winding pipe 131 and the terminal ends 138b of the two cables 138 are unwound. In this manner, the operation member 133 fixed to the second end 132b of the light shielding sheet 132 slides the shoe members 135 on the guide rails 116 and moves the shoe members 135 rearward. When the operation member 133 is moved substantially toward the rear by the maximum amount to the proximity of the rear housing 118, the light shielding sheet 132 permits the passage of light through the front panel 13 and the rear panel 14.

The winding pipe 131 and its peripheral structure will now be described.

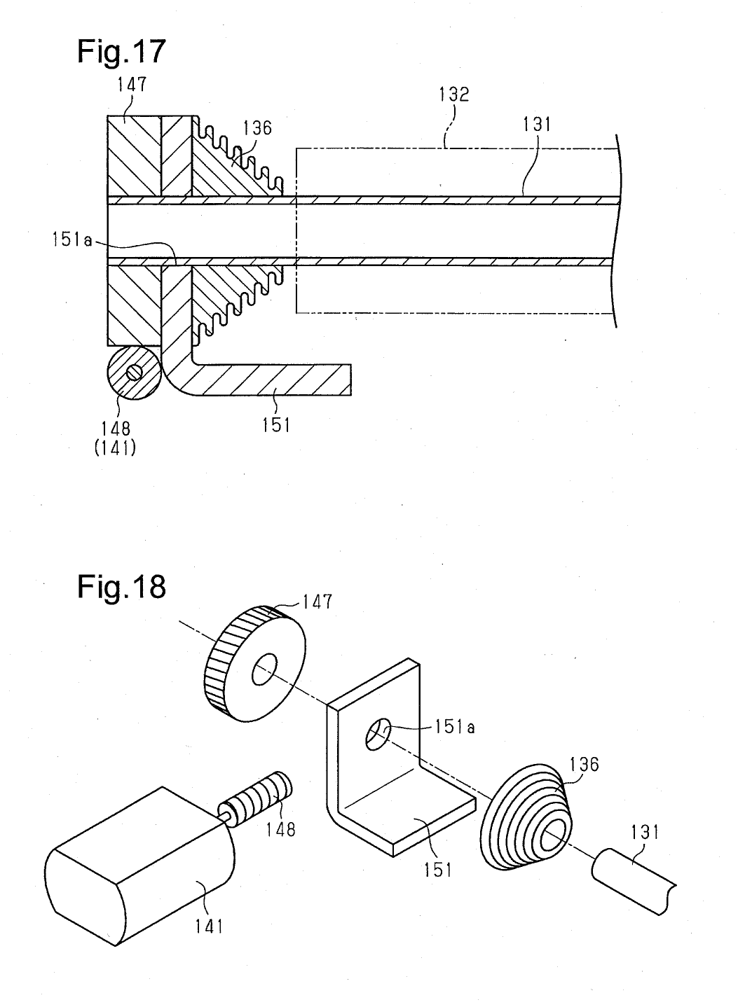

As shown in FIGS. 17 and 18, a substantially L-shaped bracket 151 is attached to the each guide rail 116 adjacent to the outer side of the drum 136. The bracket 151 includes a substantially circular bearing hole 151a that is concentric with the winding pipe 131 and opens in the vehicle transverse direction. The inner diameter of the bearing hole 151a is equal to the outer diameter of the winding pipe 131. The winding pipe 131 is inserted into the bearing hole 151a and rotatably supported by the bracket 151.

The worm wheel 147 is located adjacent to the outer side of the corresponding bracket 151. That is, the bracket 151 is located between the drum 136 and the worm wheel 147 in the vehicle transverse direction. The worm 148 of the motor 141 is engaged with the worm wheel 147 from the lower side.

The operation member 133 and its peripheral structure will now be described.

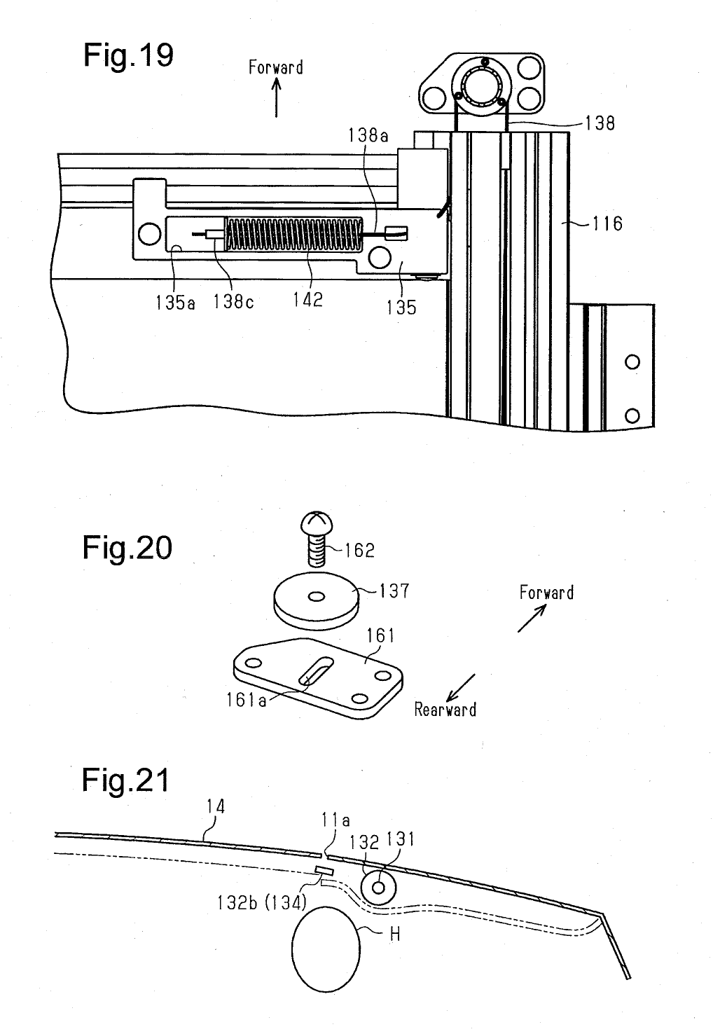

As shown in FIG. 19, each shoe member 135 includes an accommodation portion 135a that is substantially concentric with the linking portion 138a of the cable 138. One end of the linking portion 138a that enters the accommodation portion 135a is fixed to a cable end member 138c that is slidable in the accommodation portion 135a in the vehicle transverse direction. Further, a biasing member 142 such as a compressed coil spring is wound around the end of the linking portion 138a located in the accommodation portion 135a. The biasing member 142 is located between a wall surface of the accommodation portion 135a and the cable end member 138c. The biasing member 142 biases the cable end member 138c to move the cable end member 138c inward, that is, in a direction in which the cable 138 is unwound from the drum 136. The direction in which the cable 138 is unwound from the drum 136 matches the direction in which the second end 132b of the light shielding sheet 132 moves rearward.

The coupling structure of the pulley 137 will now be described.

As shown in FIG. 20, a substantially flat plate-like bracket 161, which is for example formed from a metal plate, is arranged on each end of the front housing 117 in the vehicle transverse direction where the corresponding pulley 137 is arranged. The bracket 161 includes a coupling hole 161a that opens in the vertical direction. The coupling hole 161a is substantially oval and extends in the forward and rearward directions. The pulley 137 is fastened to the front housing 117 and rotatably supported by the front housing 117 in a state in which a fastener 162 such as a bolt is inserted through a central part of the pulley 137 and into the coupling hole 161a of the bracket 161. Thus, a coupling position of the pulley 137 relative to the bracket 161 is adjustable in the forward and rearward directions in the coupling hole 161a. This adjusts the tension on the cable 138 during a process for coupling the shade mechanism 130 by changing the distance between the drum 136 and the pulley 137 in the forward and rearward directions. When the coupling position of the pulley 137 is moved relatively forward, the tension on the cable 138 increases. In contrast, when the coupling position of the pulley 137 is moved rearward, the tension on the cable 138 decreases.

As described above, the second embodiment has the advantages described below in addition to advantages (1) and (6) of the first embodiment.

(1) The motor 141 and the biasing member 142 are located outside the winding pipe 131. This decreases the outer diameter of the winding pipe 131 in a range that does not affect winding of the light shielding sheet 132. Accordingly, the light shielding sheet 132 when in the retracted state has a smaller diameter. This reduces the vertical space required below the rear end of the rear panel 14 (second position). Therefore, the recess 12 can be formed while limiting the effects on the action of the light shielding sheet 132. That is, even when the central portion of the roof panel 11 with respect to the vehicle transverse direction is recessed to form the recess 12, the light shielding sheet 132 when in the retracted state has a small vertical dimension thereby allowing for the arrangement of the shade mechanism 130. This provides a shade device that opens and closes the large opening 11a with a single shade mechanism 130.

As shown in FIG. 21, even when the light shielding sheet 132 in the retracted state is located above the head H of a passenger in the rear seat, sufficient space for the head H is obtained. This obtains a sufficient amount of opening enough for the entrance of light through the rear panel 14 and further obtains the sense of freedom. This further improves the marketability of the sunroof device.

(2) When unwinding the light shielding sheet 132 from the winding pipe 131 to the deployed state, the motor 141 rotates the drums 136 so that the drums 136 wind the cables 138. That is, the motor 141 is driven to move the second end 132b forward and deploy the light shielding sheet 132. In this case, the biasing member 142 arranged in each shoe member 135 biases the cable 138 in a manner such that the cable 138 is unwound from the drum 136. That is, the biasing member 142 biases the cable 138 so as to move the second end 132b of the light shielding sheet 132 forward. In this manner, when deploying the light shielding sheet 132, the winding pipe 131 is rotated while maintaining the tension on the light shielding sheet 132. This limits slack and the formation of creases in the light shielding sheet 132.

(3) When mounting the pulley 137, the tension on the cable 138 can be adjusted by changing the distance between the pulley 137 and the drum 136. This allows the tension on the right cable 138 to be set to be equal to the tension on the left cable 138, and the shoe members 135 can be moved in synchronization in a forward or rearward direction. Thus, the handle 134 and the second end 132b of the light shielding sheet 132 are stably held when moved.

(4) When deploying the light shielding sheet 132, even if a rotation difference occurs between the right and left drums 136, which wind the two cables 138, and desynchronizes rotation of the right and left drums 136, the biasing members 142 adjust the two cables 138 so that the second end 132b of the light shielding sheet 132 can be moved parallel to the forward and rearward directions.

The above embodiments may be modified as described below.

As shown in FIG. 15, a roof 110, which is similar to the roof 10, may include a recess 112 formed in the central portion with respect to the vehicle transverse direction and extending beyond the front end of a roof panel 111 to a rear end of a rear panel 114. That is, part of the recess 112 may be formed in the rear panel 114. The recess (112) may extend beyond the rear panel 114 to the rear end of the front panel (13).

In the first embodiment, the second cables 29 may be omitted. In this case, the winding pipe 21 may incorporate a motor that directly rotates the winding pipe 21 in the rotation direction in which the light shielding sheet 22 is wound.

In the first embodiment, the first cable 28 may be omitted. In this case, the winding pipe 21 may incorporate a motor that rotates the winding pipe 21 in the rotation direction in which the light shielding sheet 22 is unwound.

In the first embodiment, at least one of the rear shade mechanism 20 and the front shade mechanism 30 may be omitted.

In the second embodiment, at least one of the drum 136 and the worm wheel 147 may be joined with the winding pipe 131 through welding.

In the second embodiment, the handle 134 may include the accommodation portion 135a for the cable end member 138c or the like.

In the second embodiment, rotation can be transmitted between the winding pipe 131 and the motor 141 by a gear mechanism other than a worm gear, a link mechanism, a cam mechanism, a cable (rope, belt) transmission mechanism, a screw mechanism, or a combination of these mechanisms.

In the second embodiment, the winding pipe 131 may be a winding pipe located below the front end of the front panel 13 (first position). In this case, the first end 132a of the light shielding sheet 132 is connected to the winding pipe 131. Further, in this case, the light shielding sheet 132 is in the deployed state that blocks the light passing through the front panel 13 and the rear panel 14 as the second end 132b moves rearward (in first direction) or in the retracted state that permits the passage of light as the second end 132b moves forward (in second direction).

In each embodiment, the front panel 13 may be a fixed panel that always closes the front part of the opening 11a in the same manner as the rear panel 14.

In each embodiment, the rear panel 14 may be a movable panel configured to open and close the rear part of the opening 11a in the same manner as the front panel 13.

In each embodiment, the rear part of the opening 11a and the rear panel 14 that closes the rear part may be omitted. That is, the roof panel 11 may be a roof panel that extends forward to the rear end of the front panel 13. In this case, a recess that is formed in the rear end of the central portion with respect to the vehicle transverse direction may extend to the rear end of the front panel 13.

In each embodiment, it is preferred that the recesses 12 and 112 have an inclination angle that is approximately 15 degrees relative to a traveling direction (ground surface).

In the embodiments, the front panel 13 or the rear panel 14 may be a typical inorganic glass. Alternatively, the front panel 13 or the rear panel 14 may be reinforced glass including a compression stress layer that is formed by blowing air to quench a heated surface of a glass panel. Alternatively, the front panel 13 or the rear panel 14 may be a chemically reinforced glass including a compression stress layer that is formed by inducing ion exchange on a surface of a glass panel. Alternatively, the front panel 13 or the rear panel 14 may be a synthetic resin glass such as a polycarbonate resin or an acrylic resin.

1. A sunroof device, comprising:
a roof including a roof panel having an opening and a panel that closes the opening; and
a recess recessed downward in a central portion, with respect to a vehicle transverse direction, of a rear end of the roof.

2. The sunroof device according to claim 1, wherein the panel includes a front panel and a rear panel arranged adjacent to each other in forward and rearward directions of a vehicle, respectively, the sunroof device comprising a front shade mechanism and a rear shade mechanism that are respectively located below the front panel and the rear panel, wherein the rear shade mechanism includes:
a winding shaft disposed below a boundary of the front panel and the rear panel;
a light shielding sheet that includes a first end coupled to the winding shaft and a second end at an opposite side of the first end, wherein the light shielding sheet is configured to selectively conform to a deployed state, in which the light shielding sheet blocks light passing through the rear panel as the second end moves rearward, and a retracted state, in which the light shielding sheet permits passage of the light as the second end moves forward;
an electric drive source incorporated in the winding shaft to drive and move the second end of the light shielding sheet rearward; and
a biasing member incorporated in the winding shaft to bias and move the second end of the light shielding sheet forward.

3. The sunroof device according to claim 2, wherein the rear shade mechanism includes:
an operation member fixed to the second end of the light shielding sheet;
two drums concentric with the winding shaft and located at two sides of the winding shaft in the vehicle transverse direction, wherein the two drums are configured to be rotated and driven by two of the electric drive sources;
two direction changing members located at two sides of the opening in the vehicle transverse direction; and
a single cable that is adjustably held by the operation member extending rearward from two ends of the operation member and changed in direction by the direction changing members to extend forward, wherein the cable includes two terminal ends respectively fixed to the two drums, and the cable is wound when the two drums rotate in one direction to move the operation member rearward to unwind the light shielding sheet.

4. The sunroof device according to claim 3, wherein the rear shade mechanism includes second cables including first terminal ends respectively fixed to two ends of the operation member and second terminal ends located at opposite sides of the first terminal ends and respectively fixed to the drums, the second cables are unwound when the drums rotate in the one direction to permit rearward movement of the operation member that unwinds the light shielding sheet, and the second cables are wound when the drums rotate in a reverse direction to move the operation member forward.

5. The sunroof device according to claim 1, wherein the panel includes a front panel and a rear panel arranged adjacent to each other in forward and rearward directions, respectively, the sunroof device comprising a shade mechanism located below the front panel and the rear panel, wherein the shade mechanism includes:
a winding shaft arranged at one of a first position, which is located below a front end of the front panel, and a second position, which is located below a rear end of the rear panel;
a light shielding sheet configured to either
include a first end coupled to the winding shaft that is located at the first position and a second end at an opposite side of the first end, and selectively conform to a deployed state blocking light passing through the front panel and the rear panel as the second end moves in a first direction that is rearward, and a retracted state permitting passage of the light as the second end moves in a second direction that is forward, or
include a first end coupled to the winding shaft that is located at the second position and a second end at an opposite side of the first end, and selectively conform to a deployed state that blocks light passing through the front panel and the rear panel as the second end moves in a first direction that is forward, and a retracted state that permits passage of the light as the second end moves in a second direction that is rearward;
an electric drive source that is arranged outside the winding shaft and driven to move the second end of the light shielding sheet in the first direction; and
a biasing member arranged outside the winding shaft to bias and move the second end of the light shielding sheet in the second direction.
